(19) United States
(12) Patent Application Publication
(10) Pub. No.: US 2020/0100113 A1
(43) Pub. Date: Mar. 26, 2020

(54) METHOD OF DETECTING AND FILTERING ILLEGITIMATE STREAMS IN A SATELLITE COMMUNICATION NETWORK

(71) Applicant: THALES, COURBEVOIE (FR)

(72) Inventors: Pierre ROGNANT, TOULOUSE (FR); Nicolas VAN WAMBEKE, TOULOUSE (FR); Mathilde PEYREGA, TOULOUSE (FR)

(21) Appl. No.: 16/575,199

(22) Filed: Sep. 18, 2019

(30) Foreign Application Priority Data
Sep. 20, 2018 (FR) 1800987

(51) Int. Cl. H04W 12/08; H04W 76/10; H04B 7/185; H04L 29/06; G06N 20/00

(52) U.S. Cl. CPC H04W 12/0808; H04W 76/10; H04W 88/16; H04L 69/22; G06N 20/00; H04B 7/18517

(57) ABSTRACT

A method of detecting and filtering illegitimate communication streams in a satellite communication network is provided, the method being executed by a gateway satellite station able to establish a communication link between a satellite and an access network and comprising the steps of: receiving a communication stream originating from the satellite, determining a set of characteristics of the communication stream forming a signature of the stream, applying at least one classification algorithm so as to class the signature into a set of legitimate signatures or into a set of illegitimate signatures, if the signature is classed into the set of illegitimate signatures, filtering the communication stream, otherwise transmitting the communication stream to the access network.

### CROSS-REFERENCE TO RELATED APPLICATIONS

This application claims priority to foreign French patent application No. FR 1800987, filed on Sep. 20, 2018, the disclosure of which is incorporated by reference in its entirety.

### FIELD OF THE INVENTION

The invention relates to the field of satellite communication networks and more precisely that of the protection of such networks against attacks from malicious users who generate and transmit illegitimate communication streams with the aim of disturbing the operation of the network. The invention relates in particular to satellite communication networks between terminals and an access network for example the Internet access network.

The subject of the invention is a method for detecting and filtering illegitimate streams in a satellite communication network as well as a satellite station implementing this method.

### BACKGROUND

The context of the invention is that of communication networks allowing user terminals to access an access network via a satellite link. The access network is for example the Internet network. The user terminals are, for example, embedded on board aircraft or drones. In such a context, malicious users may take control of terminals in order to generate illegitimate communication streams that will disturb the global operation of the network. By illegitimate communication stream is meant here a communication stream generated by a malicious user with the sole aim of degrading the service rendered to the other users, for example by saturating the bandwidth of the network. A user having access to several terminals may, for example, generate a large quantity of communication streams that will consume a large part of the available bitrate and saturate the network access gateways. Hence, legitimate users of the network are penalized. In particular, attacks by distributed denial of service or “DDoS” may cause a phenomenon of funneling at the level of certain concentration points situated at the interface between the satellite links and the access network. The devices concerned are saturated and data losses for legitimate users are then possible.

Existing solutions use a remote device for cleaning the communication streams, also called a “scrubbing centre” in English. When an abnormal phenomenon is detected, all the communication streams received at the level of a point of concentration of the traffic are transmitted to this device which is in charge of analysing it and of filtering the illegitimate streams. The detection of a denial-of-service attack is usually based on observation of the visible consequences of the attack, for example when the system is disturbed or unreachable, data packets are lost or the bitrate of the traffic is abnormally high.

These solutions exhibit several drawbacks. Firstly, they do not make it possible to anticipate an attack since the intervention of the cleaning device occurs only after having detected a malfunction of the system. The system is therefore inoperative for the duration of the detection of the attack, of the transmission of the streams to the cleaning device and of the filtering of the illegitimate streams.

Another drawback of such a system is that the cleaning device is usually managed legally by a third-party entity and is remote from the point of access to the terrestrial network. Indeed, this device is managed by a service provider who provides this service to several distinct operators. The positioning of the cleaning device is therefore not controllable. Transmission of the corrupted streams to this device gives rise to problems of delay which further lengthen the duration for which the system is out of service or degraded.

Moreover, when a large number of illegitimate streams is generated, traffic congestion may always take place on the communication link to the cleaning device. Moreover, this communication link requires an infrastructure which exhibits a manufacturing cost and which is used only to transmit illegitimate streams which are not useful for the system users.

In view of all these drawbacks, a need exists for a more efficacious solution making it possible to detect and filter illegitimate communication streams by minimizing the duration for which the system is inoperative and without requiring additional communication infrastructure.

### SUMMARY OF THE INVENTION

The invention proposes a scheme for detecting and filtering illegitimate communication streams which is implemented directly in a gateway satellite station and which makes it possible to automatically detect whether or not a stream arriving at the level of the gateway is legitimate.

Thus, the invention makes it possible to act as early as possible in the transmission chain so as to detect and filter the illegitimate streams before they saturate a device situated at a point of concentration of the system. In this way, it is not necessary to wait until the system is rendered inoperative to detect a denial-of-service attack. Thus, the invention makes it possible to ensure service continuity even during such an attack. Moreover, it does not require any additional cleaning device or any dedicated communication infrastructure. Also, the implementation of the invention in each gateway station makes it possible to intervene at a level of the system where the volume of the streams is less significant and saturation of the bandwidth is not yet attained.

The subject of the invention is a method for detecting and filtering illegitimate communication streams in a satellite communication network, the method being executed by a gateway satellite station able to establish a communication link between a satellite and an access network and comprising the steps of:
receiving a communication stream originating from the satellite,
determining a set of characteristics of the communication stream forming a signature of the stream,
applying at least one classification algorithm so as to class the signature into a set of legitimate signatures or into a set of illegitimate signatures,
if the signature is classed into the set of illegitimate signatures, filtering the communication stream, otherwise transmitting the communication stream to the access network.

According to a particular aspect, the method according to the invention comprises for each new received data packet, the association of the packet with a stream signature.

According to a particular aspect of the invention, the set of legitimate signatures and the set of illegitimate signatures are predetermined on the basis of a priori observations.

According to a particular aspect of the invention, an illegitimate signature corresponds to a communication stream which exhibits a first given profile of variation of at least one of its characteristics during a first given period and then a second profile of variation different from the first profile of variation, of the at least one characteristic during a second given period.

According to a particular aspect of the invention, the determined characteristics are primary characteristics extracted from the communication stream from among the source address of the communication stream, the destination address of the communication stream, the protocol version of the communication stream, the port number of the communication stream.

According to a particular aspect of the invention, the primary characteristics are extracted from at least one header field of the received data packets.

According to a particular aspect of the invention, the determined characteristics are secondary characteristics measured on the data packets of a communication stream, from among the number of data packets transmitted by the communication stream, the duration of the communication stream, the maximum size of a packet of the communication stream, the minimum size of a packet of the communication stream, the average duration between two successive packets transmitted by the communication stream.

According to a particular aspect, the method according to the invention comprises the step of applying several distinct classification algorithms and of classing the signature into a set of legitimate signatures if at least one of the said classification algorithms classes the signature into a set of legitimate signatures.

According to a particular aspect of the invention, the classification algorithm is chosen from among a k-neighbours algorithm, a Bayesian naive classification algorithm, a least squares algorithm.

The subject of the invention is also a satellite station for establishing a communication link between a satellite and an access network, comprising a device for detecting and filtering illegitimate communication streams which is configured to execute the steps of the method for detecting and filtering illegitimate communication streams according to any one of the embodiments of the invention.

### BRIEF DESCRIPTION OF THE DRAWINGS

Other characteristics and advantages of the present invention will become better apparent on reading the description which follows in relation to the appended drawings which represent:

FIG. 1, a diagram of a satellite communication system according to the prior art,

FIG. 2, a diagram of a satellite communication system according to the invention,

FIG. 3, a diagram of a gateway station according to the invention,

FIG. 4, a flowchart describing the steps of a method for detecting and filtering illegitimate streams according to the invention.

### DETAILED DESCRIPTION

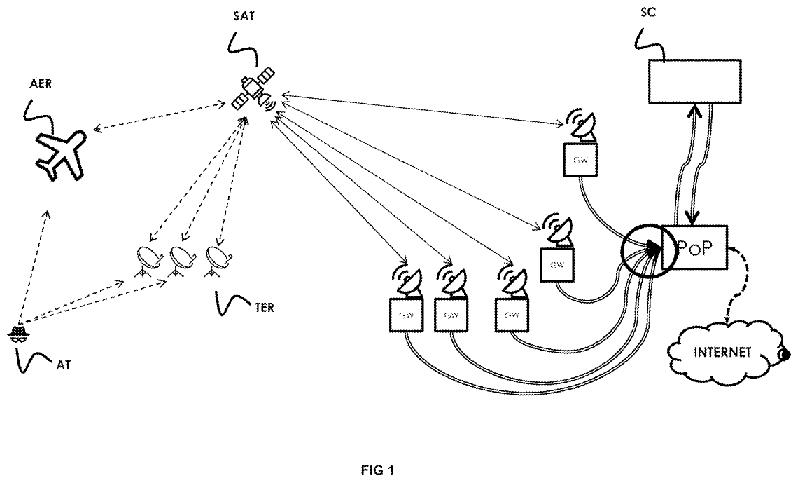

FIG. 1 illustrates, on a diagram, a satellite communication system according to the prior art in which several terminals TER, AER, which may be on the ground or embedded on board an aircraft or a drone, access a public network, for example the Internet network, via a satellite link SAT. Several gateway stations GW ensure the interface between the satellite link and the Internet network. A device PoP is positioned between the gateway stations GW and the Internet network so as to centralize the communication streams and to interconnect several networks belonging to different satellite operators. The system comprises one or more geostationary satellites SAT or a constellation of satellites in low orbit.

Such a system may be the subject of attacks originating from a malicious user AT who generates illegitimate communication streams from one or more terminals. These illegitimate communication streams are aggregated by the various gateway stations GW and may rapidly bring about saturation of the capacity of the interconnection device PoP. The legitimate communication streams may then be lost since the device PoP is no longer able to receive and process all the streams.

This type of attack is in particular known by the name denial-of-service attack. It consists, for example, in generating in a synchronous manner, a large number of communication streams which comply with the protocols of the network, but which have an abnormally high bitrate or frequency and so cannot be considered to be legitimate requests of users of the system.

An existing solution for responding to such attacks consists, when saturation of the device PoP is detected, in transmitting the communication streams to a cleaning device SC which is in charge of filtering the illegitimate streams and retransmitting the legitimate streams to the device PoP.

This solution exhibits the drawbacks discussed above.

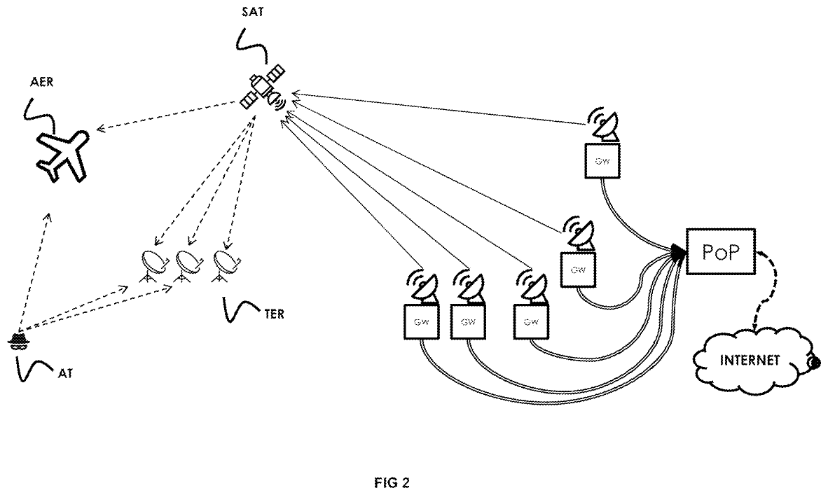

FIG. 2 represents, on a diagram, a satellite communications system including a function for detecting and filtering illegitimate streams, according to the invention.

In such a system, the remote cleaning device SC is removed and a function for detecting and filtering illegitimate streams is directly implemented in each gateway station GW.

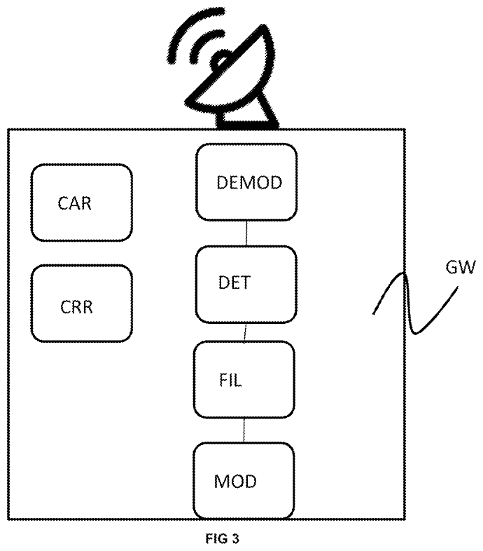

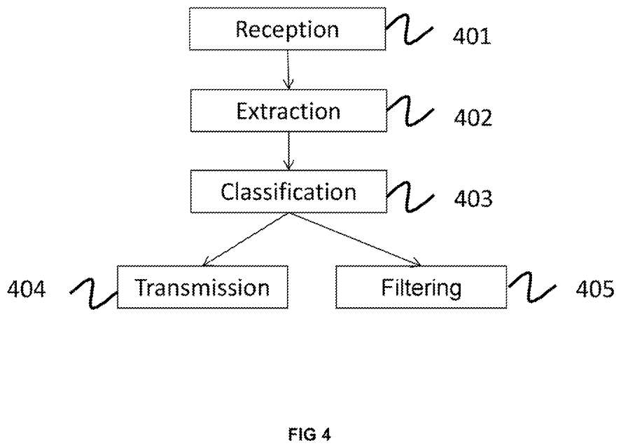

FIG. 3 shows diagrammatically an exemplary embodiment of a gateway station GW according to the invention. The station GW comprises all the devices necessary for carrying out the reception and the sending of signals over a ground-satellite link and also all the devices necessary for transmitting and receiving data from the Internet network and for interfacing this network. For example, the station GW can comprise a resources allocation controller CAR for the ground-satellite link and a radio network controller CRR for managing the interface with the Internet access network. The station GW moreover comprises a demodulator DEMOD for demodulating the signals received on the satellite link, an detector DET of illegitimate traffic among the demodulated signals, a filter FIL for filtering the detected illegitimate traffic and a modulator MOD for modulating the legitimate signals with a view to transmitting them to the access network. The detector DET and the filter FIL implement the method described in FIG. 4.

Moreover, various stations GW can communicate with one another to exchange information with a view to improving the operation of the illegitimate streams detection module.

FIG. 4 represents the main steps of a method for detecting and filtering illegitimate communication streams implemented in a gateway station GW, according to the invention.

The method starts with a step 401 of receiving communication streams originating from the link between a satellite SAT and a gateway station GW. A communication stream is composed of a set of data packets which share one or more identical characteristic(s) termed primary characteristics. These primary characteristics comprise, in particular, the type of network protocol used or the version of the protocol (IPv4 or IPv6 for example), the source and destination addresses of the packets, the port number of the transport protocol or more generally the values of certain network header fields of the packets. Generally, the value of the primary characteristics can be read in a data packet or derived directly on the basis of information contained in this packet. The primary characteristics make it possible to identify the stream to which a received packet belongs.

Other so-called secondary characteristics are also defined and associated with a received communication stream. These secondary characteristics are determined on the basis of measurements carried out on the communication stream. This entails parameters measured on an already identified communication stream. These secondary characteristics comprise in particular the total duration of the communication stream, the average duration of transmission of a packet, the average size of a packet, the maximum and minimum sizes of a packet, the transmission bitrate of the stream or the duration of the interval between two packets which is inversely proportional to the transmission bitrate of the stream to within a factor dependent on the size of the packets of the stream and more generally the variation of this bitrate or the profile of frequency-wise variation of this bitrate.

The list given of primary and secondary characteristics is not exhaustive and may be supplemented with any characteristic making it possible to identify a communication stream or any characteristic derived from measurements on this communication stream.

For each communication stream received, a set of primary and/or secondary characteristics of the stream is extracted or is measured 402 to form a signature. A signature is a set of values which can be associated with a communication stream or with several communication streams. A signature comprises a set of primary and/or secondary characteristics and is defined by the values of these characteristics for a given stream or else by a span of values of these characteristics which make it possible to define several streams. Thus, with each communication stream is associated a signature and several different streams may be associated with the same signature.

An exemplary signature is given by the set of the following characteristics {version or type of IP protocol, total number of packets of the stream, total duration of the stream, source address, destination address, maximum size of a packet, minimum size of a packet, mean time between the reception of two consecutive packets}.

More precisely, at each new data packet received, its primary characteristics are determined. If the latter correspond to a signature of an already identified stream, the new packet belongs to this stream and this signature is associated with it. If it is a new signature, it corresponds to a new stream.

Thereafter, the secondary characteristics of the signature are updated or measured on the basis of measurements on the received packet. For example, the size of the packet and the time between the reception of the packet and of the previous packet are measured. It should be noted that certain secondary characteristics such as for example the average size of a packet or the mean time between the reception of two packets makes it necessary to receive a certain number of packets of the same stream before being able to calculate the value of the characteristic.

The method thereafter continues with a classification step 403 executed for each stream identified and associated with a signature. The classification 403 of a stream consists in classing the stream either into a set of legitimate streams or into a set of illegitimate streams. If the stream is classed as being a legitimate stream, the data packets of the stream are transmitted 404 to the access network. In the converse case, they are filtered 405, that is to say they are removed and are not transmitted to the access network.

The classification procedure 403 is now described. Two sets of signatures S_I and S_i characterizing respectively the legitimate streams (S_I) and illegitimate streams (S_i) are initially available.

These two sets are determined a priori and constitute input parameters of the method according to the invention. They may for example be determined by analysing communication streams generated and controlled and then transmitted in the network, these communication streams constituting legitimate streams and making it possible to define the first set of signatures S_I. In the same manner, illegitimate streams simulating an attack by denial of service can be generated to make it possible to define the second set S_i.

An illegitimate stream is, for example, a stream of which a secondary characteristic differs greatly from the average observed for legitimate streams. For example, it may be a stream which comprises packets having a very high average size or a very low inter-packet mean time, or else a stream which exhibits a particular profile of bitrate variation, for example a packet transmission frequency which is very high for a fixed duration or according to a periodic transmission.

Another example of illegitimate stream is a stream of which certain primary and/or secondary characteristics are constant during a first given period and then highly variable during a second period.

In particular, a stream whose duration between consecutive packets is appreciably reduced after having been constant for a given duration is liable to be illegitimate. Likewise, a stream the average size of whose packets increases appreciably after having been constant for a given duration is liable to be illegitimate.

Conversely, another example of illegitimate stream is a stream certain characteristics of which are highly variable for a first given duration, for example randomly variable, and then become constant for a second duration. For example, such a stream may exhibit a random inter-packet duration and/or a highly variable size of packets for a first duration, and then suddenly, one or the other of these characteristics (or both at the same time) becomes constant.

Generally, an illegitimate stream can be characterized as being a stream which exhibits a first given profile of variation of certain characteristics during a first given period and then a second profile of variation different from the first profile of variation, for the same characteristics during a second given period.

The two sets of signatures S_I and S_i are thereafter used to parametrize at least one classification algorithm from among the following three algorithms.

A first possible classification algorithm is the k-neighbours algorithm in particular described in reference [1]. It uses the two sets S_I and S_i as training data. The k-neighbours scheme consists in classing any stream received and identified on the basis of its similarity with the examples of the two learning sets S_I and S_i, according to a metric which is, for example, the Euclidean distance or any other appropriate distance.

A second possible classification algorithm is the Bayesian naive classification algorithm which uses the two sets S_I and S_i to execute a learning phase. This second algorithm is described in reference [2]. It consists in calculating for any stream received and identified by its signature, a maximum likelihood, that is to say a probability that this stream belongs to one of the two sets S_I and S_i.

A third possible classification algorithm is a linear classification algorithm using a least squares scheme. This third algorithm is described in reference [3] and consists in determining a median hyperplane characterizing a segmentation of the space of signatures into two disjoint sets. The determination of a global optimum on a hyperplane not being trivial the hyperplane thus determined can be transformed into a convex, on which the determination of the optimum is guaranteed by a method involving an injective function. The performance of the classification procedure is therefore improved through the application of the above-mentioned transformation.

Generally, other classification algorithms are conceivable by the person skilled in the art. The common general concept of these algorithms consists, for each signature associated with a new identified stream, in investigating to which of the two sets S_I or S_i, this signature belongs, based on criteria of similarity, of probability of belonging or of proximity.

In a particular embodiment of the invention, all the available classification algorithms (for example the three algorithms described hereinabove) are executed in parallel or one after the other, for each identified stream. If at least one of the classification algorithms classes the signature of the identified stream in the set of legitimate signatures S_I, then the identified stream is considered to be a legitimate stream and is transmitted 404 to the access network. There is indeed more risk in classifying a legitimate stream as illegitimate (risk of false positive), than of classifying an illegitimate stream as legitimate (risk of false negative). It is preferable to transmit an illegitimate stream to the network rather than to wrongly block a legitimate stream. Thus, a low false positive rate is favoured to the detriment of the false negative rate. A stream is classified as being illegitimate if and only if the whole set of algorithms classifies it as such. In this case, the stream is filtered 405, that is to say the gateway station GW does not continue the processings on this stream and blocks all the new data packets received which are identified as belonging to this stream.

In another embodiment, as a supplement to this classification phase 403 which is performed locally within each of the gateway stations GW, the data collected by the various classification algorithms are used for an update of each of the classification algorithms on each gateway station GW. This update is performed by using reinforcement learning techniques. In this embodiment, a remote device receives the data collected by the classification algorithms and produces, at regular intervals, information relating to the reliability of the classification decisions made in the past. The generation of this information can be performed in an automatic manner on the basis of streams generated specifically with the aim of validating the global operation of the classification method. It can also be performed by an operator by analysing the past decisions of the classification algorithms.

The method according to the invention uses these data to update the sets of signatures S_i and S_I and, optionally, to execute a moderation of the achievements of the learning acquired in the course of the previous learning phases for each of the classification algorithms. The classification tool 403 is thus updated dynamically as a function of the successes or of the failures, that is to say whether it has or has not classified the streams correctly. This aggregation of the data is global at all the gateway stations and the parameters are therefore updated on all the gateways.

### REFERENCES

[1] O Duda, Richard & E Hart, Peter & G. Stork, David. «Pattern classification». Wiley interscience, (2001).
[2] Manning, C., Raghavan, P., & Schutze, H. (2008). “Text classification and Naive Bayes. In Introduction to Information Retrieval (pp. 234-265). Cambridge: Cambridge University Press”.
[3] R. Rifkin, G. Yeo, T. Poggio, “Regularized least-squares classification”, Nato Sci. Ser. Sub Ser. III.

1. A method of detecting and filtering illegitimate communication streams in a satellite communication network, the method being executed by a gateway satellite station able to establish a communication link between a satellite and an access network and comprising the steps of:
receiving a communication stream originating from the satellite,
determining a set of characteristics of the communication stream forming a signature of the stream,
applying at least one classification algorithm so as to class the signature into a set of legitimate signatures or into a set of illegitimate signatures,
if the signature is classed into the set of illegitimate signatures, filtering the communication stream, otherwise transmitting the communication stream to the access network.

2. The method of detecting and filtering illegitimate communication streams according to claim 1 comprising, for each new received data packet, the association of the packet with a stream signature.

3. The method of detecting and filtering illegitimate communication streams according to claim 1, wherein the set of legitimate signatures and the set of illegitimate signatures are predetermined on the basis of a priori observations.

4. The method of detecting and filtering illegitimate communication streams according to claim 1, wherein an illegitimate signature corresponds to a communication stream which exhibits a first given profile of variation of at least one of its characteristics during a first given period and then a second profile of variation different from the first profile of variation, of the at least one characteristic during a second given period.

5. The method of detecting and filtering illegitimate communication streams according to claim 1, wherein the determined characteristics are primary characteristics extracted from the communication stream from among the source address of the communication stream, the destination address of the communication stream, the protocol version of the communication stream, the port number of the communication stream.

6. The method of detecting and filtering illegitimate communication streams according to claim 5, wherein the primary characteristics are extracted from at least one header field of the received data packets.

7. The method of detecting and filtering illegitimate communication streams according to claim 1, wherein the determined characteristics are secondary characteristics measured on the data packets of a communication stream, from among the number of data packets transmitted by the communication stream, the duration of the communication stream, the maximum size of a packet of the communication stream, the minimum size of a packet of the communication stream, the average duration between two successive packets transmitted by the communication stream.

8. The method of detecting and filtering illegitimate communication streams according to claim 1 comprising the step of applying several distinct classification algorithms and of classing the signature into a set of legitimate signatures if at least one of the said classification algorithms classes the signature into a set of legitimate signatures.

9. The method of detecting and filtering illegitimate communication streams according to claim 1, wherein the classification algorithm is chosen from among a k-neighbours algorithm, a Bayesian naive classification algorithm, a least squares algorithm.

10. A satellite station (GW) for establishing a communication link between a satellite and an access network, comprising a device for detecting (DET) and filtering (FIL) illegitimate communication streams which is configured to execute the steps of the method for detecting and filtering illegitimate communication streams according to claim 1.
